(19) United States
(12) Patent Application Publication
(10) Pub. No.: US 2023/0206152 A1
(43) Pub. Date: Jun. 29, 2023

(54) DETERMINING TASK SIGNIFICANCE THROUGH TASK GRAPH STRUCTURES

(71) Applicant: Microsoft Technology Licensing, LLC, Redmond, WA (US)

(72) Inventors: Elnaz NOURI, Seattle, WA (US); Kaize DING, Tempe, AZ (US); Ryen W. WHITE, Woodinville, WA (US)

(73) Assignee: Microsoft Technology Licensing, LLC, Redmond, WA (US)

(21) Appl. No.: 17/563,302

(22) Filed: Dec. 28, 2021

(51) Int. Cl. G06Q 10/06; G06N 20/00

(52) U.S. Cl. CPC G06Q 10/06312; G06Q 10/06316; G06N 20/00

(57) ABSTRACT

Systems, storage media and methods for generating task significance information is described. The system may receive task information for a plurality of tasks; generate a task graph based on the received task information, wherein the task graph includes a plurality of nodes and at least one node of the plurality of nodes is generated for at least one task of the plurality of tasks; assign an edge type to an edge existing between the at least one node of the plurality of nodes and another node in the task graph; generate, based on at least a portion of the task graph including the edge type, task significance information for at least one task of the plurality tasks; and update at least one graphical representation of a task displayed at a user interface based on the task significance information.

### BACKGROUND

Critical tasks have significant impact on the overall process of a project. For example, a plurality of tasks may be dependent on a first task. In such a situation, the first task may be considered to be a blocking task because the blocking task is a task preventing others from completing their task until the blocking task is completed. In such situations, while a task dependent on the blocking task may be important, other tasks may become more important or otherwise more significant and/or more urgent. As another example, one or more tasks may be added, updated, or deleted, thereby affecting how important a task is and/or when a task may need to be completed. While some users may assign priority and/or significant information for their own tasks when created, such information may change when other tasks and resources change. Accordingly, there is a need to automatically adjust a significance of a task in relation to a change in circumstances.

### SUMMARY

Examples of the present disclosure are directed to determining an importance of a task based on the impact of the task to the progress of a project that may be implemented by a group or person. In examples, a representation of one or more tasks is created as nodes in a task graph, with edges being based on the people involved (e.g., people assigned to the task, people with familiarity of the task, people who the task benefit, people who receive the outcome of the task), various task resources (e.g., needed documents, communication exchanges, emails, text, etc.), and/or common features between nodes. Additional features for tasks and people (description of the tasks, due dates) further inform the task graph of the relationship between the tasks. A node classification model may then determine a significance, or priority, associated with each node in the task graph. Such significance information may then be used to rank or adjust an order of tasks being presented to a user.

In accordance with examples of the present disclosure, at least one aspect of the present disclosure relates to a method for determining task significance information for at least one task. The method may include receiving task information for a plurality of tasks. The method may include generating a task graph based on the received task information. The method may include generating, based on at least a portion of the task graph, task significance information for at least one task of the plurality tasks. The method may include updating at least one graphical representation of a task displayed at a user interface based on the task significance information.

In accordance with examples of the present disclosure, at least one aspect of the present disclosure relates to a system for determining task significance information for at least one task. The system may include one or more hardware processors configured by machine-readable instructions for determining task significance information for at least one task. The machine-readable instructions may be configured to receive task information for a plurality of tasks. The machine-readable instructions may be configured to generate a task graph based on the received task information. The machine-readable instructions may be configured to generate, based on at least a portion of the task graph, task significance information for at least one task of the plurality tasks. The machine-readable instructions may be configured to update at least one graphical representation of a task displayed at a user interface based on the task significance information.

In accordance with examples of the present disclosure, at least one aspect of the present disclosure relates to a computer-readable storage medium for determining task significance information for at least one task. In some examples, the computer-readable storage medium may include instructions being executable by one or more processors to receive task information for a plurality of tasks. In some examples, the computer-readable storage medium may include instructions being executable by one or more processors to generate a task graph based on the received task information. In some examples, the computer-readable storage medium may include instructions being executable by one or more processors to generate, based on at least a portion of the task graph, task significance information for at least one task of the plurality tasks. In some examples, the computer-readable storage medium may include instructions being executable by one or more processors to update at least one graphical representation of a task displayed at a user interface based on the task significance information.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 depicts an example of a task management system in accordance with examples of the present disclosure.

FIG. 2 depicts additional details of the task management server in accordance with examples of the present disclosure.

FIG. 3 depicts details associated with a graphical user interface in accordance with examples of the present disclosure.

FIG. 4 depicts additional details of information associated with a task in accordance with examples of the present disclosure.

FIG. 5A depicts an example graph that may be generated, updated, and/or built in accordance with examples of the present disclosure.

FIG. 5B depicts an example graph that may be generated, updated, and/or built in accordance with examples of the present disclosure.

FIG. 6 depicts an example data structure in accordance with examples of the present disclosure.

FIG. 7 depicts details of an example method for generating and updating task priority and/or urgency information in accordance with examples of the present disclosure.

FIG. 8 depicts an example method for building, generating, or otherwise updating a task graph in accordance with examples of the present disclosure.

FIG. 9 is a block diagram illustrating physical components (e.g., hardware) of a computing device with which aspects of the disclosure may be practiced.

FIGS. 10A-10B illustrate a mobile computing device with which embodiments of the disclosure may be practiced.

FIG. 11 illustrates one aspect of the architecture of a system for processing data.

### DETAILED DESCRIPTION

In the following detailed description, references are made to the accompanying drawings that form a part hereof and in which are shown by way of illustrations specific embodiments or examples. These aspects may be combined, other aspects may be utilized, and structural changes may be made without departing from the present disclosure. Examples may be practiced as methods, systems, or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In accordance with examples of the present disclosure, task importance may be determined for a task based on the impact the task may have toward the progress of a project. That is, an importance of a task can be determined based on the impact the task has on a project to which the task belongs, is assigned to, or is otherwise associated with. In examples, various tasks are created and may be represented as nodes in a graph, where edges of the graph may be based on the resources, such as personnel, that may be involved. A weighted edge can then be created between two tasks if there exists a commonality between the two tasks. For example, where two tasks have a resource (e.g., person or people) in common, an edge have a weight may be created between the two tasks. Additional features for tasks and people, such as but not limited to a description of the tasks, due dates of the task, task dependencies, and resources, may further serve to inform the graph of the relationship between the tasks. A node classification process may be utilized to learn the priority and importance of the tasks and predict or otherwise assign a label to the tasks, where the label may be utilized in a ranking algorithm to rank the nodes based on the importance. The determined importance of the task may then be presented in a user interface. In some examples, where a task importance may change, a notification may be presented to the user interface thereby informing the user of the change in task importance.

In accordance with examples of the present disclosure, task importance may be utilized among a group of tasks and/or resources, where some tasks may be more important than other tasks (e.g., deemed critical) because such tasks may have a significant impact on the overall process of the project. As an example, a task may be classified as a blocking task because many resources or people may dependent on the completion of the task. Thus, the importance of the tasks can be determined based on their impact on the progress of the project. The tasks, represented as nodes in a graph, may be connected using edges that are determined based on the people, or resources, that are involved with these tasks (e.g., assigners, assignees, reviewers, commenters, etc.). Thus, a weighted edge between two tasks may be created if there are people, or other resources, that are common to the two tasks. Additional task-related features may be used to inform the graph of the relationship between the tasks. Accordingly, a classification process may determine or otherwise generate a classification priority and importance of the tasks which may then be used to rank the tasks (e.g., nodes). In examples, the relationship between the tasks and people may be used for determining important tasks, rather than using task specific information (e.g., dependency, due dates) alone.

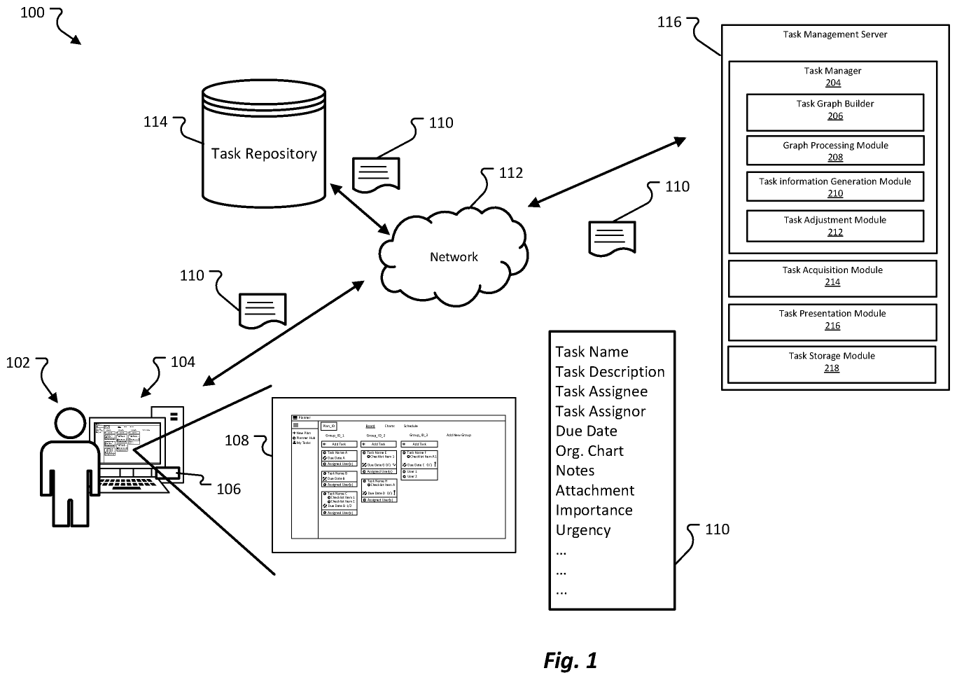

FIG. 1 depicts an example of a task management system 100 in accordance with examples of the present disclosure. The task management system 100 allows a user 102 to enter information for one or more tasks into a task repository 114 using a computing device 104. In examples, the computing device 104 may execute one or more applications 106 that may be specific to capturing task information and displaying tasks and task information associated with one or more users and one or more projects to the user 102; such tasks and task information may be rendered as part of a graphical user interface 108 to a display device of the computing device 104. In examples, information associated with a task may include task feature information 110; such task feature information 110 may be captured via the computing device 104 and sent to the task repository 114 via the network 112. The task feature information 110 may be the same as or similar to a task attribute or parameter, where the task attribute or parameter generally represents a quality or feature regarded as a characteristic or inherent part of the task. In examples, a user 102 may directly enter or otherwise provide information for the task feature information 110 via the computing device 104; alternatively, or in addition, the task feature information 110 may be generated, determined, captured, etc. by another process or application. For example, a plurality of tasks and/or subtasks may be automatically generated based on a natural language processing process, image analysis process, and/or a task generative model. In examples, the task feature information 110 may include inter-task information, such as but not limited to a first task being dependent on a second task. Such inter-task information may be provided directly by a user 102 or may be generated, determined, captured, etc. by another process or application.

The task management system 100 may utilize a task management server 116 to assign a priority for a task, where task priority may comprise a task urgency and/or a task importance. For example, the task management server 116 may receive task feature information 110 associated with a specific task using a task acquisition module. A task information generation module of the task manager may generate a value representing a task priority, also referred to as the task significance. That is, the task management server 116 may receive the task feature information 110 associated with a specific task from the task repository 114. The task management server 116 may utilize the task graph builder of the task manager to generate, build, or update a graph associated with the task or otherwise that includes the task. For example, a task may be represented as a node in a graph including a plurality of nodes, where edges between nodes may represent a commonality between each node or task. A commonality between nodes may be based on one or more of the task features from the task feature information 110 being the same.

In examples, the graph may be localized to a specific project, to a specific individual, and/or to a specific hierarchical task. That is, one or more graphs may be generated, built, updated, etc. based on a specified criteria. For example, multiple graphs may be arranged or otherwise generated based on the same plurality of nodes; thus, one or more graphs may be generated or otherwise structured in a manner that is specific to people, specific to a task, specific to a task assigner, specific to a utilized resource, or otherwise specific to another relationship that may be common between tasks. As a non-limiting example, where each node is structured based on a person, an edge may be generated by a graph processing module; the edge may represent a commonality between two nodes, such as a common task to which the two nodes (e.g., people) belong, a common due date, a common sub-task, a common blocking task, a common parent task, a common assigner, a common organization chart, etc. As another non-limiting example, where each node is structured based on a task, an edge may be generated by a graph processing module; the edge may represent a commonality between two nodes, such as a common person to which the two nodes (e.g., same task) belong, a common due date, a common sub-task, a common blocking task, a common parent task, a common assigner, a common organization chart, etc. As another non-limiting example, where each node is structured based on a due date, an edge may be generated by a graph processing module; the edge may represent a commonality between two nodes, such as a common person to which the two nodes (e.g., same task) belong, a common sub-task, a common blocking task, a common parent task, a common assigner, a common organization chart, etc. The graph processing module may assign a weight to each edge based on one or more factors, including but not limited to a distance between nodes based on attribute information for a task and/or a distance between nodes based on contextual information for the task. Alternatively, or in addition, the graph may include nodes representing tasks for a plurality of projects, individuals, projects, etc. In some examples, a node may already have an assigned task priority value, where the task manager may be utilized to generate task priority values for tasks that do not have a task priority value. As another non-limiting example, the task information may include externality information and/or other meta-data indicating information about external sources that may be dependent on a task, node or otherwise, or that the task, node or other otherwise is dependent upon. As an example, where a task or node has many out-links (e.g., vertices point away from it), the more likely the task or node may be considered to be a blocking task or bottleneck.

The task information generation module may generate the task priority or task significance based on a provided graph. In examples, a plurality of different graphs (e.g., a graph where each node is structured based on a person, a graph where each node is based on a due date, a graph where each node is based on a task) may be provided to the task information generation module; the task information generation module may then generate a task priority or task significance for each task in the graph. Where the task information generation module utilized multiple graphs, a resultant task priority or task significance may be determined based on an assigned task significance or task priority from each graph. For example, a voting system or an averaging system may be used to determine a result task priority or task significance. Alternatively, or in addition, a single graph may be provided to the task information generation module and task priority or task significance may be determined. In some examples, the task information generation module may further rank one or more tasks based on the task priority or task significance. Accordingly, the task adjustment module may assign a rank, for example, to each of the tasks. The task presentation module may then cause the task to be presented to the user interface 108 at the computing device 104. Alternatively, or in addition, a task storage module may cause the task to be stored at the task management server or otherwise in the task repository 114, where the task feature information may include the task priority, task significance, and/or task rank.

In examples, the task information generation module may generate updated task information and/or task priority/task significance information based on a provided graph. In some examples, the updated task information may indicate that one or more tasks are a blocking task because many resources or people may dependent on the completion of the task. Thus, a blocking task may have a higher importance or significance because of the impact on the progress of the project or other tasks. In examples, the relationship between the tasks and people may be used for determining important tasks, rather than using task specific information (e.g., dependency, due dates) alone. As one example, where an edge between nodes in a graph indicate that an inter-task dependency exists, the graph may be transformed into a directed graph, as at least one edge may have a directionality and indicate that a first task may occur before a second task. Thus, the information generation module may determine that a specific task sequence may exist and that another task may prevent or otherwise delay another task from being completed until it is completed.

Each of the graphs that may be generated may be dynamically updated based on changing information and/or new information. For example, the addition of new information and/or new tasks or updated tasks may cause a graph to be regenerated, updated, or a new graph to be generated. In examples, a graph may change according to a time event (e.g., every hour at 1:00 PM a graph may be updated, changed, generated, etc.) or when additional or new information becomes available. Thus, the task management server 116 may receive updated task feature information 110 associated with a specific task and utilize the task graph builder of the task manager to generate, build, or update a graph associated with the task or otherwise that includes the task. For example, edges of a node may change depending on the updated or new information. In some examples, task sequencing and/or information related to task sequencing may be added or changed. That is, based on updated task information, a new task dependency may exist and/or a task may be identified as a blocking task.

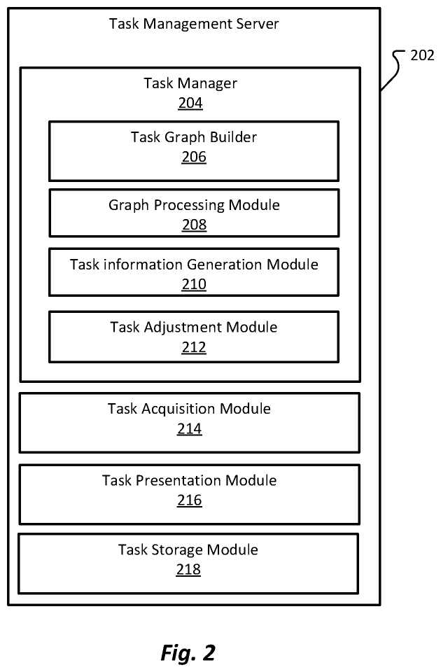

FIG. 2 depicts additional details of the task management server 202 in accordance with examples of the present disclosure. That is, a task management server 202 may be the same as or similar to the task management server 116 previously described. More specifically, the task management server 202 may acquire task information utilizing a task acquisition module 214. The task information received by the task acquisition module 214 may include task feature information, such as task feature information 110 as previously described. In examples, the task management server 202 may store the received task information at or via a task storage module 218. The task management server 202 may to assign a priority for a task, where task priority may comprise an indication of task urgency and/or a task importance as previously discussed. As an example, the task information generation module 210 of the task management server 202 may generate a value representing a task priority, or also referred to as a task significance. Such value may be indicative of a task urgency and/or task priority.

The task management server 202 may receive task feature information associated with a specific task and utilize a task graph builder 206 to generate, build, or update a graph associated with the task or otherwise includes the task. For example, a task may be represented as a node in a graph that includes a plurality of nodes, where edges between nodes may represent a commonality between each node or task. A commonality between nodes may be based on one or more of the task features being the same. In examples, the graph may be localized or otherwise generated to be specific to a criteria. For example, the graph may be specific to a project, to an individual, and/or to a parent task. In examples, a user may provide the criteria to which the graph may be specific. Alternatively, or in addition, graphs may be generated according to a predetermined set of criteria.

In examples, multiple graphs may be arranged or otherwise generated based on the same or differing plurality of nodes depending on what task feature information is available. Thus, one or more graphs may be generated or otherwise structured in a manner that is specific to people, specific to a task, specific to a task assigner, specific to a utilized resource, or otherwise specific to another relationship that may be common between tasks. As a non-limiting example, where each node is structured based on a person or people, an edge may be generated by the graph processing module 208, where the edge may represent a commonality between two nodes, such as a common task to which the two nodes (e.g., people) belong, a common due date, a common sub-task, a common blocking task, a common parent task, a common assigner, a common organization chart, etc. As another non-limiting example, where each node is structured based on a task, an edge may be generated by the graph processing module 208, where the edge may represent a commonality between two nodes, such as a common person to which the two nodes (e.g., same task) belong, a common due date, a common sub-task, a common blocking task, a common parent task, a common assigner, a common organization chart, etc. As another non-limiting example, where each node is structured based on a due date, an edge may be generated by the graph processing module 208, where the edge may represent a commonality between two nodes, such as a common person to which the two nodes (e.g., same task) belong, a common sub-task, a common blocking task, a common parent task, a common assigner, a common organization chart, etc. The graph processing module 208 may assign a weight to each edge based on one or more factors, including but not limited to a distance between nodes based on attribute information for a task and/or a distance between nodes based on contextual information for the task. Alternatively, or in addition, the graph may include nodes representing tasks for a plurality of projects, individuals, projects, etc. In some examples, a node may already have an assigned task priority value, where the task manager may be utilized to generate task priority values for tasks, or nodes, that do not have a task priority value.

The task information generation module 210 may generate the task priority or task significance based on a provided graph. In examples, a plurality of different graphs (e.g., a graph where each node is structured based on a person, a graph where each node is based on a due date, a graph where each node is based on a task) may be provided to the task information generation module; the task information generation module may then generate a task priority or task significance for each task in the graph. Where the task information generation module utilizes multiple graphs, a resultant task priority or task significance may be determined based on an assigned task significance or task priority from each graph. For example, a voting system or an averaging system may be used to determine a result task priority or task significance. Alternatively, or in addition, a single graph may be provided to the task information generation module 210 and task priority or task significance may be determined.

In some examples, the task information generation module 210 may traverse a graph of people involved in the task and identify those tasks that have a larger number of people involved and may include those people that viewed the task. Accordingly, based on a frequency of activity, a task may have a relationship with many other tasks and may act as a blocking task or otherwise has a blocking relationship with other tasks, or may have a high urgency/due date. Thus, importance and/or significance can be decided based on frequency of activity such that the task information generation module 210 may learn the representations of the nodes and be trained as a model to classify the nodes. The task information generation module 210 may predict the attributes, such as task feature information, for the unlabeled nodes in the task graph.

In some examples, the task information generation module 210 may further rank one or more tasks based on the task priority or task significance. Accordingly, the task adjustment module 212 may assign a rank, for example, to each of the tasks. The task presentation module 216 may then cause the task and associated task information to be presented to a user interface at a computing device. Alternatively, or in addition, a task storage module 218 may cause the task and associated task information to be stored at the task management server 202 or otherwise in a task repository, where task feature information for a processed task may include the task priority, task significance, and/or task ranking information. Alternatively, or in addition, the task graph may be utilized for purposes other than ranking one or more tasks and/or presenting task information to a user interface at a computing device. For example, the task graph may be utilized graph learning, task sequencing, and/or for making task assignments.

In examples, the generation of the task significance information may be performed by a machine learning model trained on training data, where the training data may be representative of a task and task significance information and further task feature information. In some examples, such information is provided by a graph. In some examples, the machine learning model may be implemented at a neural network and may take an input vector comprising the task feature information and generate a corresponding task significance information and/or task ranking information. Accordingly, a task adjustment module, such as the task adjustment module 212, may assign a rank, for example, to each of the tasks as previously described. In examples, the task adjustment module may update the tasks with the generated task information (e.g., priority and ranking information) and may utilize a machine learning model trained on ranking information and/or implemented as a neural network.

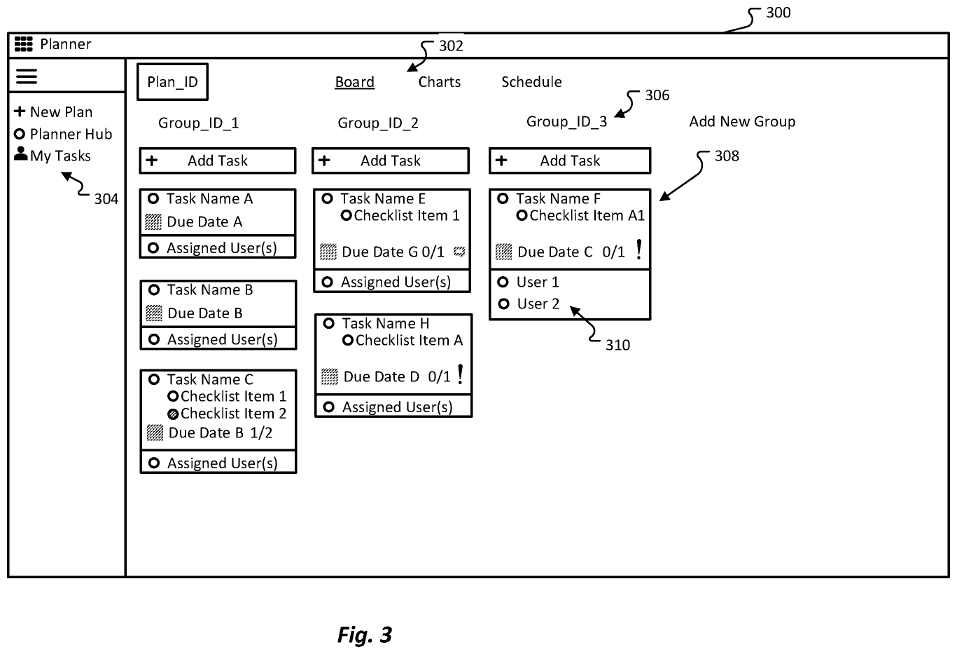

FIG. 3 depicts details associated with a graphical user interface 300 in accordance with examples of the present disclosure. The graphical user interface 300 may be representative of a graphical user interface of a project or task planning application, where such application may be the same as or similar to the one or more applications 106. In examples, such application may be accessible via web browser or may run locally on a computing device, such as the computing device 104. In examples, the graphical user interface 300 may include a selection pane 304 that allows a user to select one or more plans that include one or more tasks. In examples, a plan may be representative of the information depicted as 302, where the information depicted as 302 may present, render, or otherwise display task related information in an organized manner. Such task related information may include high level task feature information arranged as a board of tasks, as a chart of tasks, or as a schedule of tasks. As depicted in FIG. 3, task feature information is presented as a board of tasks. Each task may be associated with a group identifier 306, such as Group_ID_1, Group_ID_2, etc. In accordance with examples of the present disclosure, the high level task feature information may be presented in a board representation 308 form and may include but is not limited to task name, due date if known, assigned user(s) 310, checklist of items (e.g., subtask information), and completion status of task and checklist items. Of course, each board representation 308 of each task may display more or less information and/or different information than that which is depicted in FIG. 3. Similarly, each board representation 308 of each task may display information that is different from another board representation.

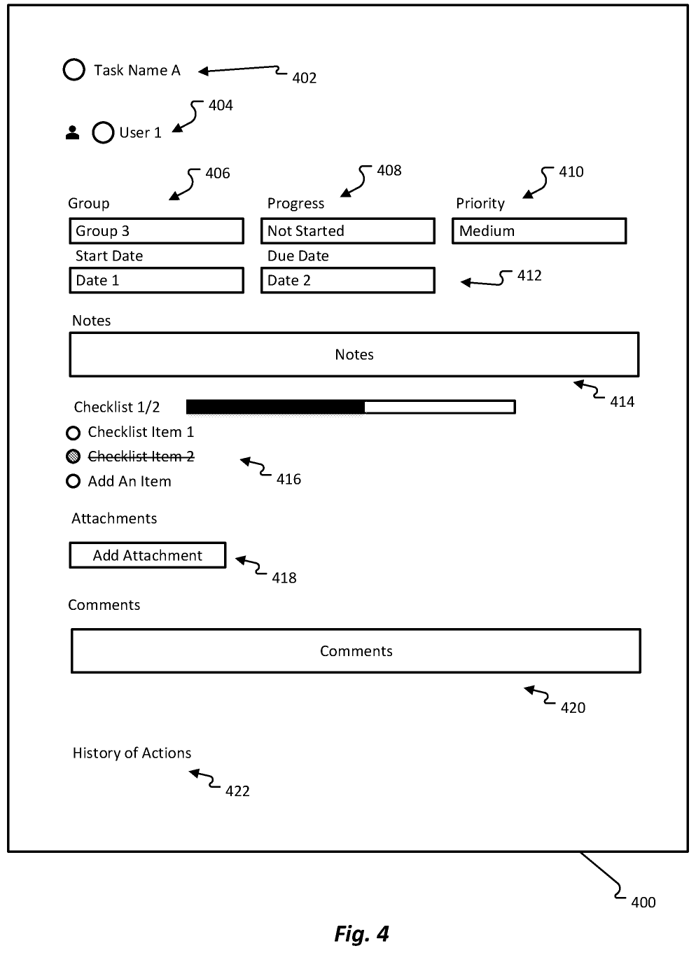

FIG. 4 depicts additional details of information associated with a task in accordance with examples of the present disclosure. For example, a user interface 400 may allow a user, such as user 102, to enter, edit, and/or delete information associated with a task. For example, the user interface 400 may provide a user the ability to add or edit a task name using an input element 402, the assigned users associated with the task (e.g., task name) using an input element 404, a group to which the task belongs using an input element 406, progress information associated with the task using the input element 408, user designated priority information associated with the task using the input element 410, additional text or notes using the input element 414, and subtask or other checklist information using the input element 416. In some examples, the user interface 400 may allow a user to add additional comments to the task using the comments input element 420 which may be a text box for example. As further depicted in FIG. 4, attachments may be included with or otherwise associated with the task using the attachment input element 418. Further, a history of actions may be displayed via the output element 422. The information entered into and/or displayed via the one or more input and/or output elements depicted in FIG. 4 may be an example of task feature information. Of course, other task feature information may be associated with a task.

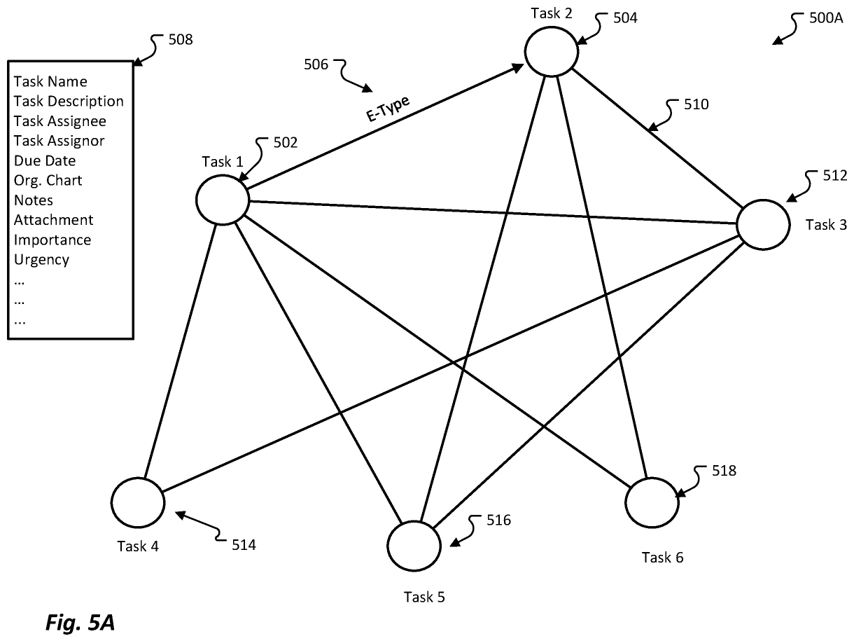

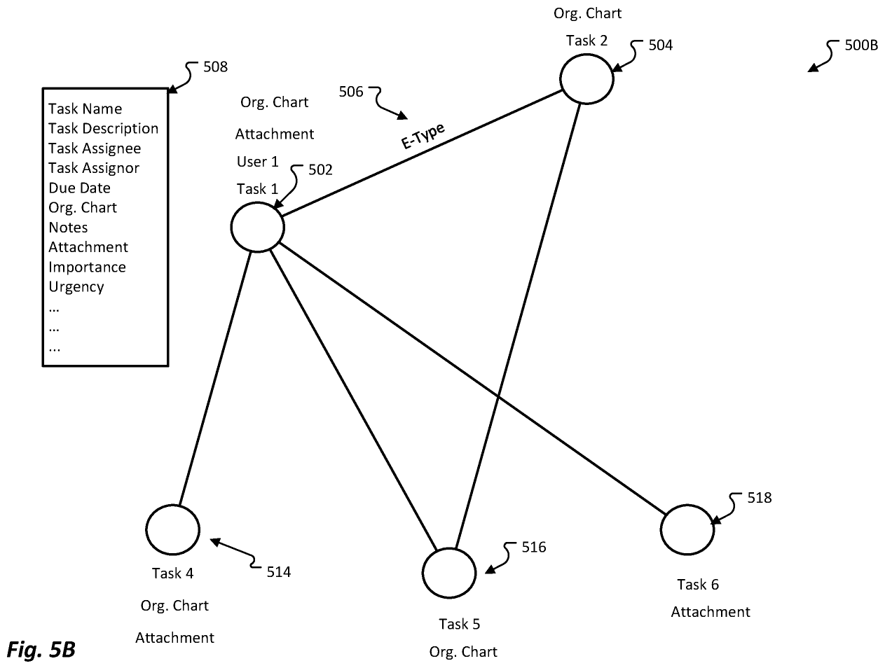

FIG. 5A depicts an example graph 500A that may be generated, updated, and/or built in accordance with examples of the present disclosure. The example graph 500A depicts a plurality of tasks as nodes including task 1 node 502, task 2 node 504, task 3 node 512, task 4 node 514, task 5 node 516, and task 6 node 518. The plurality of nodes depicted in FIG. 5A may be associated with a person, project, or other information. In examples, an edge may be generated between nodes of the example graph 500A, where each edge may represent a commonality between two nodes or otherwise indicate task feature information 508 that is common between two nodes. For example, an edge 506 may be of a first edge type, where an edge type may be indicative of the task feature information 508 that is common between the two nodes (e.g., task 1 node 502 and task 2 node 504). Thus, the edge 506 may have an edge type equal to “person” or “resource,” indicating that the task 1 as represented by node 502 has a person or resource that is common with task 2 as represented by node 504. Alternatively, or in addition, the edge 506 may have an edge type equal to “due date” indicating that the task 1 as represented by node 502 has a due date that is common with task 2 as represented by node 504. Other edges are depicted between the task 1 node 502 and other nodes. As another example, an edge 510 may be associated with a common checklist item, a common assignee, a common project, a common task, a common blocking task, etc. Although FIG. 5A depicts a single edge between nodes, it should be understood that multiple edges may exist between nodes. In some examples, the multiple commonalities (or edges) between nodes may be indicative or otherwise configure an edge type such that a single edge type represents the commonalities (or categories of commonalities) between nodes. For example, a first edge type may indicate that two nodes have a person and a due date in common. As another example, another edge type may indicate that two nodes have a checklist and a task assigner in common. As another example, where an edge between nodes that an inter-task dependency exists, the graph may be transformed into a directed graph, as at least one edge may have a directionality and indicate that a first task may occur before a second task. Thus, a specific task sequence may exist and one task may prevent or otherwise delay another task from being completed until it is completed.

In accordance with examples of the present disclosure, each edge created or otherwise existing in the example graph 500A may be assigned or otherwise have assigned a weighted value. In some examples, the weighted value may represent an amount of similarity between nodes having one or more edges. Alternatively, or in addition, the weighted value may represent a distance (e.g., based on a similarity determination and/or graph/node contextual information) between nodes.

FIG. 5B depicts an example graph 500B that may be generated, updated, and/or built in accordance with examples of the present disclosure. The example graph 500B depicts a plurality of tasks as nodes including task 1 node 502, task 2 node 504, task 4 node 514, task 5 node 516, and task 6 node 518. The plurality of nodes depicted in FIG. 5B may be associated with a person, project, or other information. In examples, the example graph 500B may be different from the example graph 500A in that the example graph 500B may be limited to, specific to, or otherwise localized to a specific criteria. For example, the example graph 500B may be limited to only those nodes associated with a particular user. While all nodes displayed in the example graph 500B would at least have the specific user in common, the example graph 500B further depicts one or more edges specifying a different commonality that exists between nodes. For example, an edge or edge type 506 may indicate that the node 502 and node 504 have an organization chart in common. As another example, another edge type between node 502 and node 516 may indicate that the commonality is an organization chart. As another example, another edge type between node 504 and node 516 may indicate that the commonality is an organization chart. As another example, another edge type between node 502 and node 518 may indicate that the commonality is an attachment. As another example, another edge type between node 502 and node 514 may indicate that the commonality is an organization chart and an attachment. Of course other commonalities and edge types are contemplated.

In accordance with examples of the present disclosure, each edge created or otherwise existing in the example graph 500B may be assigned or otherwise have assigned a weighted value. In some examples, the weighted value may represent an amount of similarity between nodes having one or more edges. Alternatively, or in addition, the weighted value may represent a distance (e.g., based on a similarity determination and/or graph/node contextual information) between nodes.

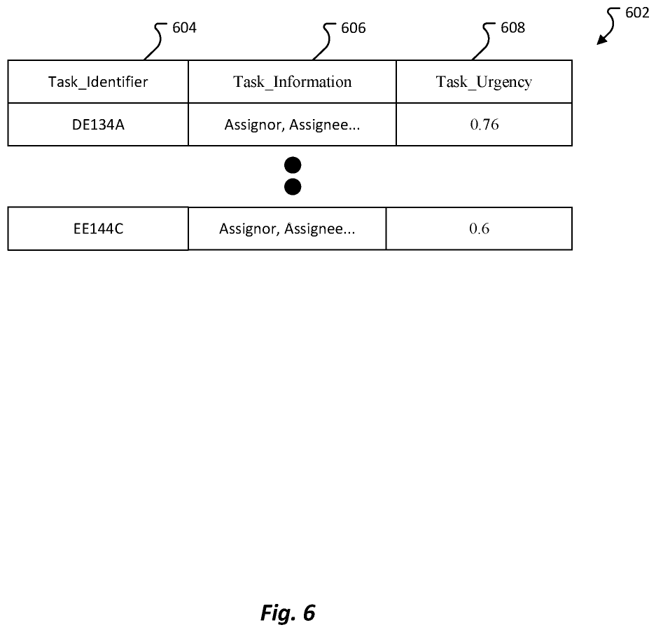

FIG. 6 depicts an example data structure 602 in accordance with examples of the present disclosure. The example data structure 602 may include task feature information associated with a task in addition to other task related information. For example, the data structure 602 may include a task_identifier field 604 which includes an identifier that uniquely identifies a task, a task_information field 606 that includes task feature information as previously discussed, and/or a task_urgency field 608 that may be included with the task feature information or otherwise may be generated in accordance with the examples of the present disclosure. Of course, other task feature information may be located in or otherwise stored in association with the data structure 602.

The task_urgency field 608 may include a value for each task; alternatively, or in addition, the task_urgency field 608 may be generated for each task as previously described. That is, the task_urgency field 608 may be indicative of a task priority or urgency associated with the task. Thus, a task presentation module, such as the task presentation module 216 may utilize the information in the task_urgency field 608 to arrange or rearrange one or more tasks depicted in a user interface. For example, based on a value in the task_urgency field 608, the task presentation module 216 may cause a task depicted in the graphical user interface 300 to be moved from a first position to a second position in a specific group as displayed to a user. As another example, based on a value in the task_urgency field 608, the task presentation module 216 may cause a task depicted in the graphical user interface 300 to be moved from a third position to a first position in a specific group as displayed to a user. In some examples, the value of the task_urgency field 608 may be generated according to a time event (e.g., at 12:00 PM every day), according to a change in status of another other task (e.g., a blocking task is removed or a resource becomes available) and/or according to a time when a user accesses the application.

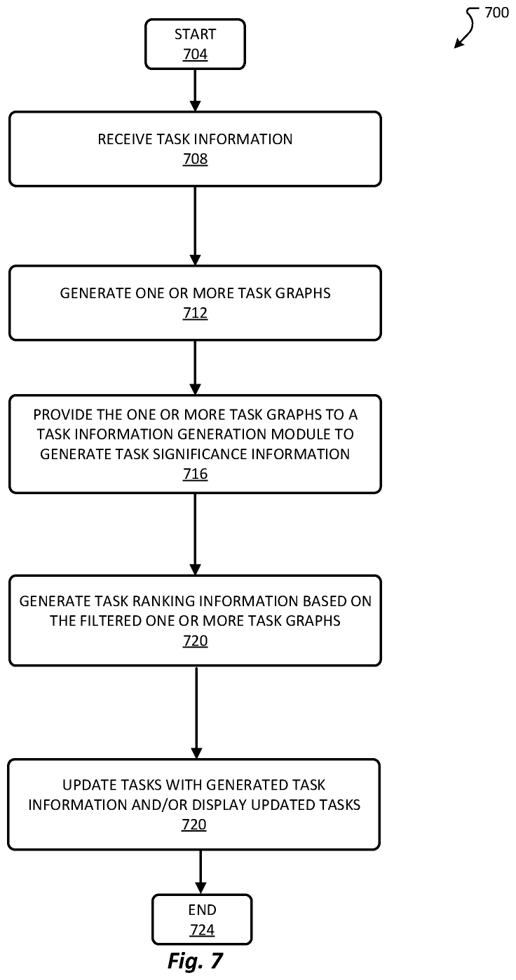

FIG. 7 depicts details of an example method 700 for generating and updating task priority and/or urgency information in accordance with examples of the present disclosure. A general order for the steps of the method 700 is shown in FIG. 7. Generally, the method 700 starts at 704 and ends at 724. The method 700 may include more or fewer steps or may arrange the order of the steps differently than those shown in FIG. 7. The method 700 can be executed as a set of computer-executable instructions executed by a computer system and encoded or stored on a computer-readable medium. Further, the method 700 can be performed by gates or circuits associated with a processor, Application Specific Integrated Circuit (ASIC), a field-programmable gate array (FPGA), a system on chip (SOC), graphics processing unit (GPU), or other hardware device. Hereinafter, the method 700 shall be explained with reference to the systems, components, modules, software, data structures, user interfaces, etc. described in conjunction with FIGS. 1-6.

The method 700 begins at operation 704 and proceeds to 708, where task information may be received. In examples, a task acquisition module (such as the task acquisition module 214) may receive task information including task feature information. For example, a user 102 at a computing device 104 may enter task information into a graphical user interface, such as the graphical user interface of FIG. 4. Such information may be stored in a task repository 114 for example, and then retrieved by the task acquisition module 214. The method 700 may then proceed to 712 where one or more task graphs may be generated. For example, a task graph builder 206 may generate, build, or update a graph associated with the received task information. A task may be represented as a node in a graph that includes a plurality of nodes, where edges between nodes may represent a commonality between each node or task. A commonality between nodes may be based on one or more of the task features being the same. In examples, the graph may be localized or otherwise generated to be specific to a criteria as previously described. For example, the graph may be specific to a project, to an individual, and/or to a parent task. In examples, a user may provide the criteria to which the graph may be specific. Alternatively, or in addition, graphs may be generated according to a predetermined set of criteria.

The method 700 may proceed to 716, where the generated one or more task graphs may be provided to a task information generation module, such as the task information generation module 210. The task information generation module may generate the task priority or task significance based on a provided graph. In examples, a plurality of different graphs (e.g., a graph where each node is structured based on a person, a graph where each node is based on a due date, a graph where each node is based on a task) may be provided to the task information generation module; the task information generation module may then generate a task priority or task significance for each task in the graph. Where the task information generation module utilizes multiple graphs, a resultant task priority or task significance may be determined based on an assigned task significance or task priority from each graph. For example, a voting system or an averaging system may be used to determine a result task priority or task significance. Alternatively, or in addition, a single graph may be provided to the task information generation module and task priority or task significance may be determined. In some examples, the task information generation module may further rank one or more tasks based on the task priority or task significance. In examples, the generation of the task significance information may be performed by a machine learning model trained on training data, where the training data may be representative of a task and task significance information and further task feature information. In some examples, such information is provided by a graph. In some examples, the machine learning model may be implemented at a neural network and may take an input vector comprising the task feature information and generate a corresponding task significance information and/or task ranking information. Accordingly, the method 700 may proceed to 720, where a task adjustment module, such as the task adjustment module 212, may assign a rank, for example, to each of the tasks as previously described. In examples, the method 700 may proceed to 720 where the task adjustment module may update the tasks with the generated task information (e.g., priority and ranking information). The task presentation module 216 may then cause the task and associated task information to be presented to a user interface at a computing device. Alternatively, or in addition, a task storage module may cause the task and associated task information to be stored at the task management server or otherwise in a task repository, where task feature information for a processed task may include the task priority, task significance, and/or task ranking information. The method may end at 724.

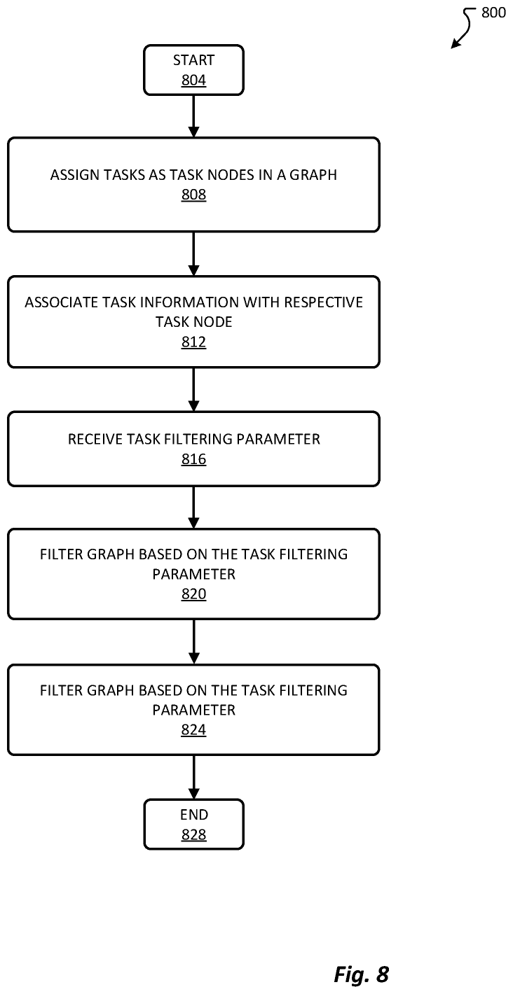

FIG. 8 depicts an example method 800 for building, generating, or otherwise updating a task graph in accordance with examples of the present disclosure. A graph may be generated, built, updated from user relationships (assignee/assignor) and other task related information. In examples, two tasks with common users may have a created or otherwise generated common edge between users. Thus, relationships between entities may be incorporated providing more information than task nodes and/or user nodes. A general order for the steps of the method 800 is shown in FIG. 8. Generally, the method 800 starts at 804 and ends at 828. The method 800 may include more or fewer steps or may arrange the order of the steps differently than those shown in FIG. 8. The method 800 can be executed as a set of computer-executable instructions executed by a computer system and encoded or stored on a computer readable medium. Further, the method 800 can be performed by gates or circuits associated with a processor, Application Specific Integrated Circuit (ASIC), a field-programmable gate array (FPGA), a system on chip (SOC), graphics processing unit (GPU), or other hardware device. Hereinafter, the method 800 shall be explained with reference to the systems, components, modules, software, data structures, user interfaces, etc. described in conjunction with FIGS. 1-7.

The method 800 begins at operation 804 and proceeds to 808 where nodes in a task graph are generated. For example, the task graph builder 206 may receive a list of tasks and generate a task node or otherwise verify that a task node exists for each task in the list of tasks. At 812, task information including, but not limited to, task feature information may be associated with respective task nodes in the task graph. That is, task nodes may include information including but not limited to textual features, titles, descriptions, textual features, telemetry features. Numerical features—ex. how many changes for each field, changes for description, assignor and assignee may also be incorporated as task feature information. Further, at 812, edges between task nodes may be generated or otherwise defined. For example, edges may be defined based on who is assigning tasks to whom (assignee/assignor relationship). In some examples, a task may have an order of operations and an edge may be defined or otherwise based on the order of operation.

The method 800 may proceed to 816 where a filtering parameter or criteria may be received. For example, the graph may be localized or otherwise generated to be specific to a criteria or received parameter. The graph may be specific to a project, to an individual, and/or to a parent task. In examples, a user may provide the criteria to which the graph may be specific such that only those nodes satisfying the filtering criteria are used to generated priority information. Alternatively, or in addition, graphs may be generated according to a predetermined set of criteria. In examples, multiple graphs may be arranged or otherwise generated based on the same or differing plurality of nodes depending on what task feature information is available. Thus, one or more graphs may be generated or otherwise structured in a manner that is specific to people, specific to a task, specific to a task assigner, specific to a utilized resource, or otherwise specific to another relationship that may be common between tasks. As a non-limiting example, where each node is structured based on a person or people, an edge may be generated by the graph processing module, where the edge may represent a commonality between two nodes, such as a common task to which the two nodes (e.g., people) belong, a common due date, a common sub-task, a common blocking task, a common parent task, a common assigner, a common organization chart, etc. As another non-limiting example, where each node is structured based on a task, an edge may be generated by the graph processing module, where the edge may represent a commonality between two nodes, such as a common person to which the two nodes (e.g., same task) belong, a common due date, a common sub-task, a common blocking task, a common parent task, a common assigner, a common organization chart, etc. As another non-limiting example, where each node is structured based on a due date, an edge may be generated by the graph processing module, where the edge may represent a commonality between two nodes, such as a common person to which the two nodes (e.g., same task) belong, a common sub-task, a common blocking task, a common parent task, a common assigner, a common organization chart, etc.

At 824, a graph processing module may assign a weight to each edge based on one or more factors, including but not limited to a distance between nodes based on attribute information for a task and/or a distance between nodes based on contextual information for the task. Alternatively, or in addition, the graph may include nodes representing tasks for a plurality of projects, individuals, projects, etc. The method 800 may then end at 828.

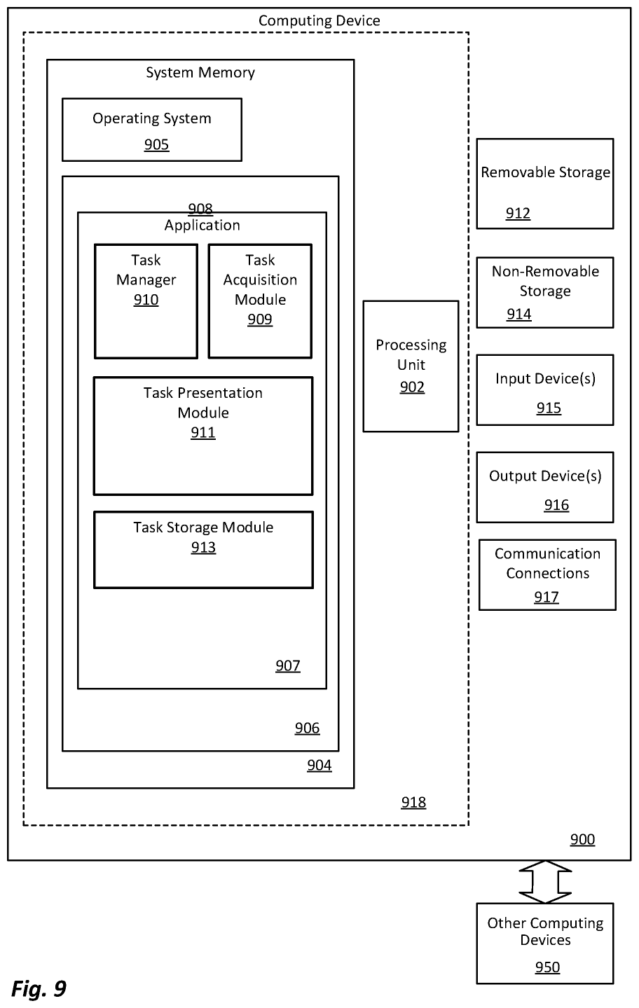

FIGS. 9-11 and the associated descriptions provide a discussion of a variety of operating environments in which aspects of the disclosure may be practiced. However, the devices and systems illustrated and discussed with respect to FIGS. 9-11 are for purposes of example and illustration and are not limiting of a vast number of computing device configurations that may be utilized for practicing aspects of the disclosure, described herein.

FIG. 9 is a block diagram illustrating physical components (e.g., hardware) of a computing system 900 with which aspects of the disclosure may be practiced. The computing device components described below may be suitable for the computing and/or processing devices described above. In a basic configuration, the computing system 900 may include at least one processing unit 902 and a system memory 904. Depending on the configuration and type of computing device, the system memory 904 may comprise, but is not limited to, volatile storage (e.g., random-access memory (RAM)), non-volatile storage (e.g., read-only memory (ROM)), flash memory, or any combination of such memories.

The system memory 904 may include an operating system 905 and one or more program modules 906 suitable for running software application 907, such as one or more components supported by the systems described herein. As examples, system memory 904 may include the task manager 910, the task acquisition module 909, the task presentation module 911, and the task storage module 913. The task manager 910 may be the same as or similar to the task manager 204, the task acquisition module 909 may be the same as or similar to the task acquisition module 214, the task presentation module 911 may be same as or similar to the task presentation module 216, and the task storage module 913 may be the same as or similar to the task storage module 218 as previously described. The operating system 905, for example, may be suitable for controlling the operation of the computing system 900.

Furthermore, embodiments of the disclosure may be practiced in conjunction with a graphics library, other operating systems, or any other application program and is not limited to any particular application or system. This basic configuration is illustrated in FIG. 9 by those components within a dashed line 918. The computing system 900 may have additional features or functionality. For example, the computing system 900 may also include additional data storage devices (removable and/or non-removable) such as, for example, magnetic disks, optical disks, or tape. Such additional storage is illustrated in FIG. 9 by a removable storage device 912 and a non-removable storage device 914.

As stated above, a number of program modules and data files may be stored in the system memory 904. While executing on the processing unit 902, the program modules 906 (e.g., application 907) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided programs, etc.

Furthermore, examples of the present disclosure may be practiced in an electrical circuit discrete electronic element, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 9 may be integrated onto a single integrated circuit. Such an SOC device may include one or more processing units, graphics units, communications units, system virtualization units and various application functionality, all of which are integrated (or “burned”) onto the chip substrate as a single integrated circuit. When operating via an SOC, the functionality, described herein, with respect to the capability of client to switch protocols may be operated via application-specific logic integrated with other components of the computing system 900 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

The computing system 900 may also have one or more input device(s) 915 such as a keyboard, a mouse, a pen, a sound or voice input device, a touch or swipe input device, etc. The output device(s) 916 such as a display, speakers, a printer, etc. may also be included. The aforementioned devices are examples and others may be used. The computing system 900 may include one or more communication connections 917 allowing communications with other computing devices 950. Examples of suitable communication connections 917 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and non-volatile, removable, and non-removable media implemented in any method or technology for storage of information, such as computer readable instructions, data structures, or program modules. The system memory 904, the removable storage device 912, and the non-removable storage device 914 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information, and which can be accessed by the computing system 900. Any such computer storage media may be part of the computing system 900. Computer storage media does not include a carrier wave or other propagated or modulated data signal.

Communication media may be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

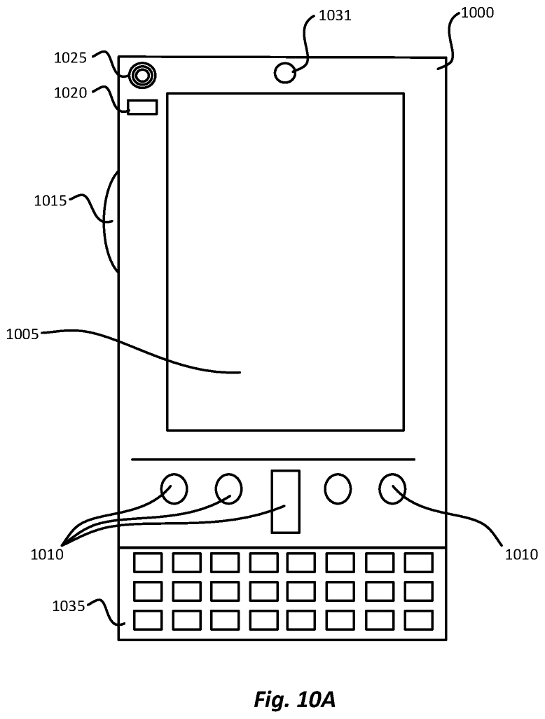

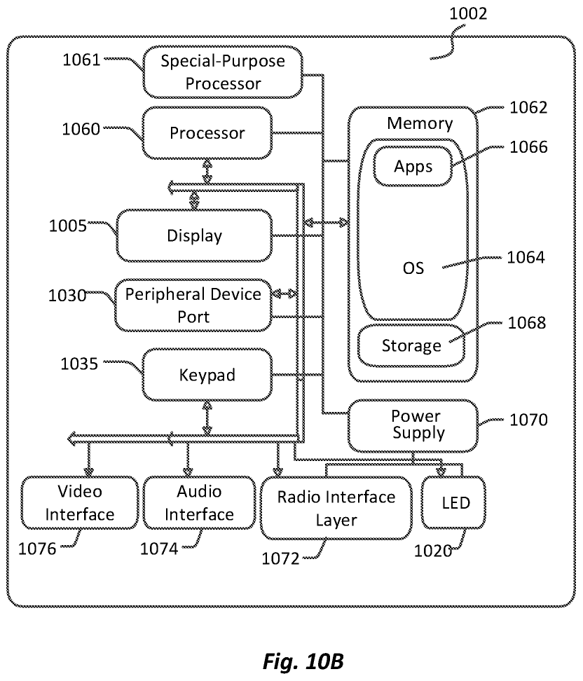

FIGS. 10A-10B illustrate a mobile computing device 1000, for example, a mobile telephone, a smartphone, wearable computer (such as a smartwatch), a tablet computer, a laptop computer, and the like, with which embodiments of the disclosure may be practiced. In some respects, the client may be a mobile computing device. With reference to FIG. 10A, one aspect of a mobile computing device 1000 for implementing the aspects is illustrated. In a basic configuration, the mobile computing device 1000 is a handheld computer having both input elements and output elements. The mobile computing device 1000 typically includes a display 1005 and one or more input buttons 1010 that allow the user to enter information into the mobile computing device 1000. The display 1005 of the mobile computing device 1000 may also function as an input device (e.g., a touch screen display).

If included, an optional side input element 1015 allows further user input. The side input element 1015 may be a rotary switch, a button, or any other type of manual input element. In alternative aspects, mobile computing device 1000 may incorporate greater or fewer input elements. For example, the display 1005 may not be a touch screen in some embodiments.

In yet another alternative example, the mobile computing device 1000 is a portable phone system, such as a cellular phone. The mobile computing device 1000 may also include an optional keypad 1035. Optional keypad 1035 may be a physical keypad or a “soft” keypad generated on the touch screen display.

In various examples, the output elements include the display 1005 for showing a graphical user interface (GUI), a visual indicator 1020 (e.g., a light-emitting diode), and/or an audio transducer 1025 (e.g., a speaker). In some aspects, the mobile computing device 1000 incorporates a vibration transducer for providing the user with tactile feedback. In yet another aspect, the mobile computing device 1000 incorporates input and/or output ports, such as an audio input (e.g., a microphone jack), an audio output (e.g., a headphone jack), and a video output (e.g., a HDMI port) for sending signals to or receiving signals from an external device.

FIG. 10B is a block diagram illustrating the architecture of one aspect of a mobile computing device. That is, the mobile computing device 1000 can incorporate a system (e.g., an architecture) 1002 to implement some aspects. In one embodiment, the system 1002 is implemented as a “smart phone” capable of running one or more applications (e.g., browser, email, calendaring, contact managers, messaging clients, games, and media clients/players). In some aspects, the system 1002 is integrated as a computing device, such as an integrated personal digital assistant (PDA) and wireless phone.

One or more application programs 1066 may be loaded into the memory 1062 and run on or in association with the operating system 1064. Examples of the application programs include phone dialer programs, email programs, personal information management (PIM) programs, word processing programs, spreadsheet programs, Internet browser programs, messaging programs, and so forth. The system 1002 also includes a non-volatile storage area 1068 within the memory 1062. The non-volatile storage area 1068 may be used to store persistent information that should not be lost if the system 1002 is powered down. The application programs 1066 may use and store information in the non-volatile storage area 1068, such as email or other messages used by an email application, and the like. A synchronization application (not shown) also resides on the system 1002 and is programmed to interact with a corresponding synchronization application resident on a host computer to keep the information stored in the non-volatile storage area 1068 synchronized with corresponding information stored at the host computer. As should be appreciated, other applications may be loaded into the memory 1062 and run on the mobile computing device 1000 described herein (e.g., search engine, extractor module, relevancy ranking module, answer scoring module, etc.).

The system 1002 has a power supply 1070, which may be implemented as one or more batteries. The power supply 1070 might further include an external power source, such as an AC adapter or a powered docking cradle that supplements or recharges the batteries.

The system 1002 may also include a radio interface layer 1072 that performs the function of transmitting and receiving radio frequency communications. The radio interface layer 1072 facilitates wireless connectivity between the system 1002 and the “outside world,” via a communications carrier or service provider. Transmissions to and from the radio interface layer 1072 are conducted under control of the operating system 1064. In other words, communications received by the radio interface layer 1072 may be disseminated to the application programs 1066 via the operating system 1064, and vice versa.

The visual indicator 1020 may be used to provide visual notifications, and/or an audio interface 1074 may be used for producing audible notifications via the audio transducer 1025. In the illustrated embodiment, the visual indicator 1020 is a light-emitting diode (LED), and the audio transducer 1025 is a speaker. These devices may be directly coupled to the power supply 1070 so that when activated, they remain on for a duration dictated by the notification mechanism even though the processor 1060 and other components might shut down for conserving battery power. The LED may be programmed to remain on indefinitely until the user takes action to indicate the powered-on status of the device. The audio interface 1074 is used to provide audible signals to and receive audible signals from the user. For example, in addition to being coupled to the audio transducer 1025, the audio interface 1074 may also be coupled to a microphone to receive audible input, such as to facilitate a telephone conversation. In accordance with embodiments of the present disclosure, the microphone may also serve as an audio sensor to facilitate control of notifications, as will be described below. The system 1002 may further include a video interface 1076 that enables an operation of an onboard camera 1030 to record still images, video stream, and the like.

A mobile computing device 1000 implementing the system 1002 may have additional features or functionality. For example, the mobile computing device 1000 may also include additional data storage devices (removable and/or non-removable) such as, magnetic disks, optical disks, or tape. Such additional storage is illustrated in FIG. 10B by the non-volatile storage area 1068.

Data/information generated or captured by the mobile computing device 1000 and stored via the system 1002 may be stored locally on the mobile computing device 1000, as described above, or the data may be stored on any number of storage media that may be accessed by the device via the radio interface layer 1072 or via a wired connection between the mobile computing device 1000 and a separate computing device associated with the mobile computing device 1000, for example, a server computer in a distributed computing network, such as the Internet. As should be appreciated such data/information may be accessed via the mobile computing device 1000 via the radio interface layer 1072 or via a distributed computing network. Similarly, such data/information may be readily transferred between computing devices for storage and use according to well-known data/information transfer and storage means, including electronic mail and collaborative data/information sharing systems.

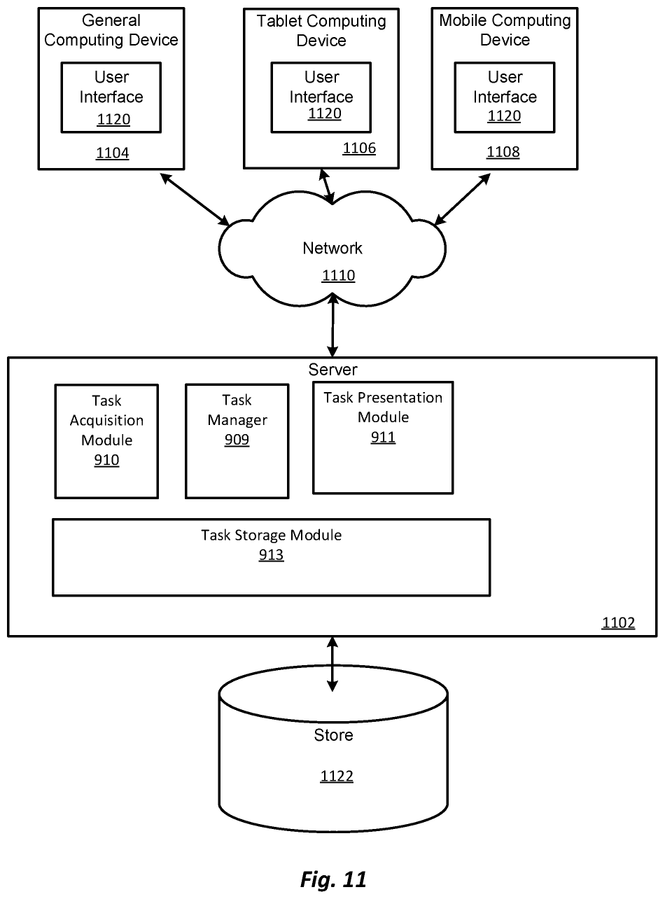

FIG. 11 illustrates one aspect of the architecture of a system for processing data received at a computing system from a remote source, such as a personal computer 1104, tablet computing device 1106, or mobile computing device 1108, as described above. The personal computer 1104, tablet computing device 1106, or mobile computing device 1108 may include a user interface 1120 allowing a user to interact with one or more program modules as previously described. One or more of the previously described program modules 906 or software applications 907 may be employed by server device 1102 and/or the personal computer 1104, tablet computing device 1106, or mobile computing device 1108, as described above. For example, the server device 1102, and in many examples the personal computer 1104, tablet computing device 1106, and/or mobile computing device 1108 may include the task manager 910, the task acquisition module 909, the task presentation module 911, and the task storage module 913. The task manager 910 may be the same as or similar to the task manager 204, the task acquisition module 909 may be the same as or similar to the task acquisition module 214, the task presentation module 911 may be same as or similar to the task presentation module 216, and the task storage module 913 may be the same as or similar to the task storage module 218 as previously described.

The server device 1102 may provide data to and from a client computing device such as a personal computer 1104, a tablet computing device 1106 and/or a mobile computing device 1108 (e.g., a smartphone) through a network 1110. By way of example, the computer system described above may be embodied in a personal computer 1104, a tablet computing device 1106 and/or a mobile computing device 1108 (e.g., a smartphone) and may be the same as or similar to the computing device 104. Any of these examples of the computing devices may obtain content from the store 1122, in addition to receiving graphical data useable to be either pre-processed at a graphic-originating system, or post-processed at a receiving computing system. The store 1122 may also include the document & content repository 1124, which may be the same as or similar to the document & content repository 248 previously described.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via onboard computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The present disclosure relates to systems and methods for assigning task significance to one or more tasks according to at least the examples provided in the sections below:

(A1) In one aspect, some examples include a method for determining and/or assigning task significance information for one or more task. The method may include: receiving task information for a plurality of tasks, generating a task graph based on the received task information, generating, based on at least a portion of the task graph, task significance information for at least one task of the plurality tasks and updating at least one graphical representation of a task displayed at a user interface based on the task significance information.

(A2) In some examples of A1, the method further includes: ranking the at least one task of the plurality of tasks based on the task significance information; and updating the at least one graphical representation of the task displayed at the user interface based on the rank associated with the at least one task of the plurality of tasks.

(A3) In some examples of A1-A2, the method further includes: receiving a filtering parameter; filtering the plurality of nodes using the received filtering parameter to obtain a first task graph; and generating, based on the first task graph, task significance information for the at least one task of the plurality tasks.

(A4) In some examples of A1-A3, the method further includes: receiving a second filtering parameter; filtering the plurality of nodes using the received second filtering parameter to obtain a second task graph; and generating, based on the first task graph and the second task graph, task significance information for the at least one task of the plurality tasks.

(A5) In some examples of A1-A4, the method further includes: receiving, at a machine learning model trained on task significance information, at least a portion of the task graph; and generating, based on the at least a portion of the task graph, the task significance information for the least one task of the plurality tasks using the machine learning model.

(A6) In some examples of A1-A5, the method further includes: assigning an edge type to an edge existing between the at least one node of the plurality of nodes and another node in the task graph.

(A7) In some examples of A1-A6, the edge type between the at least one node of the plurality of nodes and the other node in the task graph is based on task information that is common to the at least one node of the plurality of nodes and the other node in the task graph.

(A8) In some examples of A1-A7, the task information includes at least one of an assignee, assignor, due date, resource, a priority information, and a dependency on another task.

(A9) In some examples of A1-A8, the method further includes: receiving second task information for the plurality of tasks; updating an existing task graph based on the received second task information, wherein the updated task graph includes a plurality of nodes and at least one node of the plurality of nodes is generated for at least one task of the plurality of tasks generating, based on at least a portion of the updated task graph, task significance information for at least one task of the plurality tasks; and updating at least one graphical representation of a task displayed at a user interface.

(A10) In some examples of A1-A9, the method further includes: identifying the at least one task as a blocking task based on the at least one node of the plurality of nodes having a plurality of inter-task dependencies.

In yet another aspect, some examples include a system including one or more processors and memory coupled to the one or more processors, the memory storing one or more instructions which when executed by the one or more processors, causes the one or more processors to perform any of the methods described herein (e.g., A1-A10 described above).

In yet another aspect, some examples include a computer-readable storage medium storing one or more programs for execution by one or more processors of a device, the one or more programs including instructions for performing any of the methods described herein (e.g., A1-A10 described above).

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system, comprising:
one or more hardware processors configured by machine-readable instructions to:
receive task information for a plurality of tasks;
generate a task graph based on the received task information, wherein the task graph includes a plurality of nodes and at least one node of the plurality of nodes is generated for at least one task of the plurality of tasks;
assign an edge type to an edge existing between the at least one node of the plurality of nodes and another node in the task graph;
generate, based on at least a portion of the task graph including the edge type, task significance information for at least one task of the plurality tasks; and
update at least one graphical representation of a task displayed at a user interface based on the task significance information.

2. The system of claim 1, wherein the one or more hardware processors are further configured by machine-readable instructions to:
rank the at least one task of the plurality of tasks based on the task significance information; and
update the at least one graphical representation of the task displayed at the user interface based on the rank associated with the at least one task of the plurality of tasks.

3. The system of claim 2, wherein the one or more hardware processors are further configured by machine-readable instructions to:
receive a filtering parameter;
filter the plurality of nodes using the received filtering parameter to obtain a first task graph; and
generate, based on the first task graph, task significance information for the at least one task of the plurality tasks.

4. The system of claim 3, wherein the one or more hardware processors are further configured by machine-readable instructions to:
receive a second filtering parameter;
filter the plurality of nodes using the received second filtering parameter to obtain a second task graph; and
generate, based on the first task graph and the second task graph, task significance information for the at least one task of the plurality tasks.

5. The system of claim 1, wherein the one or more hardware processors are further configured by machine-readable instructions to:
receive, at a machine learning model trained on task significance information, at least a portion of the task graph; and
generate, based on the at least a portion of the task graph, the task significance information for the least one task of the plurality tasks using the machine learning model.

6. The system of claim 1, wherein the edge type between the at least one node of the plurality of nodes and the other node in the task graph is based on task information that is common to the at least one node of the plurality of nodes and the other node in the task graph.

7. The system of claim 1, wherein the task information includes at least one of an assignee, assignor, a due date, a resource, a priority information, and a dependency on another task.

8. The system of claim 1, wherein the one or more hardware processors are further configured by machine-readable instructions to:
receive second task information for the plurality of tasks;
update an existing task graph based on the received second task information, wherein the updated task graph includes a plurality of nodes and at least one node of the plurality of nodes is generated for at least one task of the plurality of tasks;
generate, based on at least a portion of the updated task graph, task significance information for at least one task of the plurality tasks; and
update at least one graphical representation of a task displayed at a user interface.

9. The system of claim 1, wherein the one or more hardware processors are further configured by machine-readable instructions to:
identify the at least one task as a blocking task based on the at least one node of the plurality of nodes having a plurality of inter-task dependencies.

10. A method, comprising:
receiving task information for a plurality of tasks;
generating a task graph based on the received task information, wherein the task graph includes a plurality of nodes and at least one node of the plurality of nodes is generated for at least one task of the plurality of tasks;
generating, based on at least a portion of the task graph, task significance information for at least one task of the plurality tasks; and
updating at least one graphical representation of a task displayed at a user interface based on the task significance information.

11. The method of claim 10, further comprising:
ranking the at least one task of the plurality of tasks based on the task significance information; and
updating the at least one graphical representation of the task displayed at the user interface based on the rank associated with the at least one task of the plurality of tasks.

12. The method of claim 11, further comprising:
receiving a filtering parameter;
filtering the plurality of nodes using the received filtering parameter to obtain a first task graph; and
generating, based on the first task graph, task significance information for the at least one task of the plurality tasks.

13. The method of claim 12, further comprising:
receiving a second filtering parameter;
filtering the plurality of nodes using the received second filtering parameter to obtain a second task graph; and
generating, based on the first task graph and the second task graph, task significance information for the at least one task of the plurality tasks.

14. The method of claim 10, further comprising:
receiving, at a machine learning model trained on task significance information, at least a portion of the task graph; and
generating, based on the at least a portion of the task graph, the task significance information for the least one task of the plurality tasks using the machine learning model.

15. The method of claim 10, further comprising assigning an edge type to an edge existing between the at least one node of the plurality of nodes and another node in the task graph.

16. The method of claim 15, wherein the edge type between the at least one node of the plurality of nodes and the other node in the task graph is based on task information that is common to the at least one node of the plurality of nodes and the other node in the task graph.

17. The method of claim 10, wherein the task information includes at least one of an assignee, assignor, due date, resource, and priority information.

18. The method of claim 10, further comprising:
receiving second task information for the plurality of tasks;
updating an existing task graph based on the received second task information, wherein the updated task graph includes a plurality of nodes and at least one node of the plurality of nodes is generated for at least one task of the plurality of tasks;
generating, based on at least a portion of the updated task graph, task significance information for at least one task of the plurality tasks; and
updating at least one graphical representation of a task displayed at a user interface.

19. A computer-readable storage medium comprising instructions being executable by one or more processors to perform a method, the method comprising:
receiving task information for a plurality of tasks;
generating a task graph based on the received task information, wherein the task graph includes a plurality of nodes and at least one node of the plurality of nodes is generated for at least one task of the plurality of tasks;
generating, based on at least a portion of the task graph, task significance information for at least one task of the plurality tasks;
ranking the at least one task of the plurality of tasks based on the task significance information; and
updating at least one graphical representation of a task displayed at a user interface based on the ranking.

20. The computer-readable storage medium of claim 19, wherein the instructions cause the one or more processors to:
receive a filtering parameter;
filter the plurality of nodes using the received filtering parameter to obtain a first task graph; and
generate, based on the first task graph, task significance information for the at least one task of the plurality tasks.
